(19) United States
(12) Patent Application Publication
(10) Pub. No.: US 2007/0002296 A1
(43) Pub. Date: Jan. 4, 2007

(54) Immersion lithography defect reduction

(75) Inventors: Ching-Yu Chang, Yilang City (TW); Vincent Yu, Taichung County (TW); Chin-Hsiang Lin, Hsin-Chu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 11/384,624

(22) Filed: Mar. 20, 2006

Related U.S. Application Data
(60) Provisional application No. 60/695,562, filed on Jun. 30, 2005.

(51) Int. Cl. G03B 27/42

(52) U.S. Cl. 355/53

(57) ABSTRACT

A method of performing immersion lithography on a semiconductor substrate includes providing a layer of resist onto a surface of the semiconductor substrate and exposing the resist layer using an immersion lithography exposure system. The immersion lithography exposure system utilizes a fluid during exposure and may be capable of removing some, but not all, of the fluid after exposure. After exposure, a treatment process is used to remove the remaining portion of fluid from the resist layer. After treatment, a post-exposure bake and a development step are used.

This application claims priority to U.S. application Ser. No. 60/695,562 filed Jun. 30, 2005 entitled, “Immersion Lithography Defect Reduction.”

This application is related to U.S. application Ser. No. 11/271,639 filed Nov. 10, 2005 entitled “Water Mark Defect Prevention for Immersion Lithography,” which claims priority to U.S. application Ser. No. 60/722,646 filed Sep. 30, 2005; U.S. application Ser. No. 11/324,588 filed Jan. 3, 2006 entitled, “Novel TARC Material for Immersion Watermark Reduction,” which claims priority to U.S. application Ser. No. 60/722,316 filed Sep. 30, 2005 and 60/722,646 filed Sep. 30, 2005; and U.S. application Ser. No.______filed______entitled, “Immersion Lithography Watermark Reduction,” which claims priority to U.S. application Ser. No. 60/705,795 filed Aug. 5, 2005.

### BACKGROUND

The present disclosure relates generally to immersion lithography, such as is used in the manufacture of semiconductor integrated circuits.

Lithography is a mechanism by which a pattern on a mask is projected onto a substrate such as a semiconductor wafer. In areas such as semiconductor photolithography, it has become necessary to create images on the semiconductor wafer which incorporate minimum feature sizes under a resolution limit or critical dimension (CD). Currently, CDs are reaching 65 nanometers and less.

Semiconductor photolithography typically includes the steps of applying a coating of photoresist on a top surface (e.g., a thin film stack) of a semiconductor wafer and exposing the photoresist to a pattern. A post-exposure bake is often performed to allow the exposed photoresist, often a polymer-based substance, to cleave. The cleaved polymer photoresist is then transferred to a developing chamber to remove the exposed polymer, which is soluble to an aqueous developer solution. As a result, a patterned layer of photoresist exists on the top surface of the wafer.

Immersion lithography is a new advance in photolithography, in which the exposure procedure is performed with a liquid filling the space between the surface of the wafer and the lens. Using immersion photolithography, higher numerical apertures can be built than when using lenses in air, resulting in improved resolution. Further, immersion provides enhanced depth-of-focus (DOF) for printing ever smaller features.

The immersion exposure step may use de-ionized water or another suitable immersion exposure fluid in the space between the wafer and the lens. Though the exposure time is short, the combination of the fluid and the photoresist (resist) can cause heretofore unforeseen problems. For example, droplets from the fluid can remain after the process and/or residue from the fluid and resist can adversely affect the patterning, critical dimensions, and other aspects of the resist. Although not intended to be limiting, at least three different fault mechanisms have been identified.

A first fault mechanism occurs when soluble material from the resist contaminates the immersion fluid, which will produce problems later in the process. A second fault mechanism occurs when the fluid adversely influences the resist, causing it to unevenly absorb heat and evaporate during a post exposure bake (PEB). As a result, a temperature profile will be different on different portions of the wafer. A third fault mechanism occurs when the fluid diffuses into the resist and limits the CAR (chemical amplify reaction) used later in the lithography process. It is understood that none of these fault mechanisms are required to reap benefits from the present invention, but are herein provided as examples.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIGS. 1, 4, and 5 are side cross sectional views of a semiconductor wafer that is undergoing an immersion lithography process.

FIG. 2 is a side-view diagram of an immersion lithography system.

FIG. 3 is a view of the semiconductor wafer of FIGS. 1, 4 and/or 5 that is suffering from one or more defects.

FIG. 6 is a flow chart of a method for implementing an immersion lithography process with reduced defects, according to one or more embodiments of the present invention.

FIGS. 7-9 are views of different treatment processes used in the immersion lithography process of FIG. 6.

### DETAILED DESCRIPTION

The present disclosure relates generally to the fabrication of semiconductor devices, and more particularly, to a method and system for the removal of photoresist residue from a semiconductor substrate. It is understood, however, that specific embodiments are provided as examples to teach the broader inventive concept, and one of ordinary skill in the art can easily apply the teachings of the present disclosure to other methods and systems. Also, it is understood that the methods and systems discussed in the present disclosure include some conventional structures and/or steps. Since these structures and steps are well known in the art, they will only be discussed in a general level of detail. Furthermore, reference numbers are repeated throughout the drawings for the sake of convenience and clarity, and such repetition does not indicate any required combination of features or steps throughout the drawings.

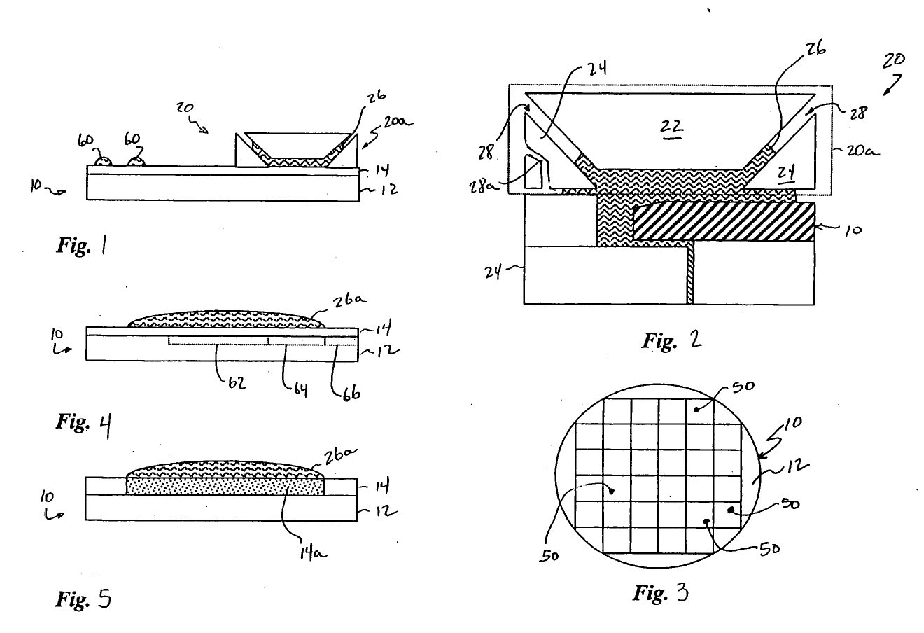

Referring to FIG. 1, a semiconductor wafer 10 includes a substrate 12 and a patterning layer 14. The substrate 12 can include one or more layers, including poly, metal, and/or dielectric, that are desired to be patterned. The patterning layer 14 can be a photoresist (resist) layer that is responsive to an exposure process for creating patterns. The wafer 10 is illustrated as being processed in an immersion lithography system 20.

Referring to FIG. 2, one example of the immersion lithography system 20 includes a lens system 22, a structure 24 for containing a fluid 26 such as de-ionized water, various apertures 28 through which fluid can be added or removed, and a chuck 30 for securing and moving the wafer 10 relative to the lens system 22. The fluid containing structure 24 and the lens system 22 make up an immersion head 20a. The immersion head 20a can use some of the apertures (e.g., aperture 28a) as an “air purge” which can purge air into the wafer for drying, and other apertures for removing any purged fluid. The air purge 28a alone may be insufficient to purge all of the fluid 26 from the wafer 10.

Referring now to FIG. 3, the wafer 10 is shown after going through a conventional immersion lithography process. The wafer 10 includes defects 50 that have been caused during the process. The defects can represent watermarks, residue or foreign particles in the patterned resist, or can represent deformation or “holes” (missing patterns) in the resist. Other types of defects may also exist. It is noted that if post-exposure bake (PEB) is increased in time or temperature to remove the watermark type defect, the likelihood of foreign particles and/or other defects increases.

Referring again to FIG. 1, the first fault mechanism for causing defects is that soluble material from the resist 14 will contaminate the residue fluid particle 60, which will produce problems later in the process. A portion of the wafer 10 that is not under the immersion head 20a is shown as having two residue fluid particles 60. The residue fluid particles 60 may comprise a soluble material from the resist 14, fluid 26, or a combination thereof. The residue particles 60 can later form defects during subsequent steps of the lithography process.

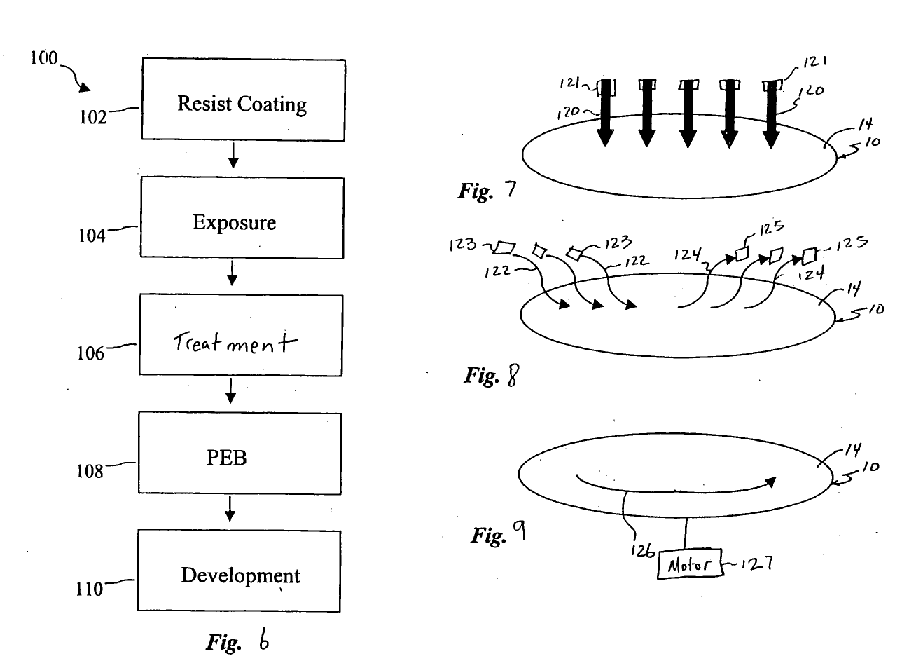

Referring to FIG.4, the second fault mechanism for causing defects, such as shown in FIG. 3, is that the fluid 26 will adversely influence the resist 14, causing it to unevenly absorb heat and evaporate during a post exposure bake (PEB). In the figure, three different portions 62, 64, 66 of the wafer 10 are illustrated for the sake of example. The portion 62 may obtain a significantly lower temperature profile during PEB than the portions 64 and 66 due to the existence of a fluid droplet 26a. As a result, the resist 14 adjacent to the portion 62 will be processed differently than the resist adjacent to the other portions 64, 66.

Referring to FIG. 5, the third fault mechanism for causing defects is that the fluid droplet 26a will diffuse into the resist 14 and will limit the CAR (chemical amplify reaction) used later in the litigation process. The figure shows an expanded view of the resist 14 and a portion of the resist 14a into which the fluid 26 has diffused. It is noted that the fluid 26 penetrates into the resist 14 very quickly. The diffused fluid limits the CAR reaction and therefore the resist 14 cannot support the pattern (or produces a poor pattern). It is desirable to remove the fluid 26 from the wafer 10 as soon as possible.

Referring to FIG. 6, a simplified flowchart of an embodiment of a process for immersion lithography with a reduced number of defects is provided. In step 102, the resist 14 is formed over the surface of the wafer substrate 12. The resist 14 may be a negative or positive resist and may be of a material now known or later developed for this purpose. For example, the resist 14 may be a one- two- or multi-component resist system. The application of the resist 14 may be done with spin-coating or another suitable procedure. Prior to the application of the resist 14, the wafer 10 may be first processed to prepare it for the photolithography process. For example, the wafer 10 may be cleaned, dried and/or coated with an adhesion-promoting material prior to the application of the resist 14.

At step 104, the immersion exposure step is performed. The wafer 10 and resist 14 are immersed in an immersion exposure liquid 26 such as de-ionized water, and exposed to a radiation source through the lens 22 (FIG. 2). The radiation source may be an ultraviolet light source, for example a krypton fluoride (KrF, 248 nm), argon fluoride (ArF, 193 nm), or F₂ (157 nm) excimer laser. The wafer 10 is exposed to the radiation for a predetermined amount of time is dependent on the type of resist used, the intensity of the ultraviolet light source, and/or other factors. The exposure time may last from about 0.2 seconds to about 30 seconds, for example.

At step 106, a treatment process is performed. The treatment process may be performed in-situ with the previous or next processing step, or may be performed in a separate chamber. There are several unique treatment processes that can by used to help reduce the problem mechanisms discussed above. These processes can be used individually or in various combinations.

Referring to FIG. 7, one or more liquids 120 can be added for the treatment process 106. The liquids 120 can be provided by one or more nozzles 121. In some embodiments, a single nozzle swings from a center point of the wafer 10 towards an outer edge of the wafer. The liquids 120 can include such things as supercritical CO2, alcohol (e.g., methanol, ethanol, isopropanol (IPA), and/or xylene), surfactants, and/or clean de-ionized water (cleaner than the “dirty” fluid that is left as a residue on the wafer 10).

In one embodiment, a supercritical fluid that includes carbon dioxide (CO2). Supercritical CO2 is used. Although supercritical CO2 has been used during other processes, it has not heretofore been used as a treatment process prior to PEB. U.S. Pat. No. 6,656,666 and the article Zhang, et al., “Chemical-Mechanical Photoresist Drying In Supercritical Carbon Dioxide With Hydrocarbon Surfactants,” J.Vac.Sci.Technol. B 22(2) p. 818 (2004) describe the use of supercritical CO2, both of which are hereby incorporated by reference. Not only do the above-listed references not apply to the present process step, but the process disclosed in these references includes additional processing material to the otherwise conventional process, which is not required in the present invention.

Similarly, solvents such as IPA have been used as a drying agent following a wet-etch procedure, but has not heretofore been used as a treatment process prior to PEB. In addition, the process for wet etching places the wafer in a vertical position, while immersion typically positions the wafer in a horizontal position. The IPA will mix with the water and improve (reduce) the evaporation point so that it will evaporate quickly.

Referring to FIG. 8, one or more gases 122 can be added for the treatment step 106. The gases 122 can be provided by one or more nozzles 123. In some embodiments, a single nozzle swings from a center point of the wafer 10 towards an outer edge of the wafer. Example gases include condensed/clean dry air (CDA), N2, or Ar for a purge dry process.

In another embodiment, a vacuum process 124, which may or may not require a separate chamber, can be used to facilitate drying. The vacuum 124 can be provided by one or more nozzles 125. The vacuum process 124 can also reduce the boiling point of the fluid and thereby facilitate the treatment process.

Referring to FIG. 9, a spin dry process 126 can be used for the treatment step 106. This may include a high-speed spin dry (e.g., greater than 1000 rpm) as provided by a motor 127. Spin dry works especially well in combination with one or more of the other above-listed treatment processes, and can typically be performed in-situ. For example, a de-ionized water rinse can be dispensed through a nozzle to dissolve and/or clean any dirty fluid droplets, either contemporaneously with or, followed immediately by a spin dry process at 1500 rpm. In some embodiments, the nozzle can swing across the surface of the wafer to facilitate the movement of the residual fluid from the center towards the edges of the spinning wafer 10. Instead of or in addition to the de-ionized water, an IPA rinse (pure or dilute) can be used to improve the evaporation point of the water and/or improve the surface tension of the wafer 10.

Referring again to FIG. 6, at step 108, the wafer 10 with the exposed and dry resist 14 is then heated for a post-exposure bake (PEB) for polymer dissolution. This step lets the exposed photo acid react with the polymer and make the polymer dissolution. The wafer may be heated to a temperature of about 85 to about 1500° C. for about 30 to about 200 seconds, for example.

In some embodiments, the PEB step 108 can be preceded by a first lower-temperature bake (e.g., 80% of what would be considered a “normal” PEB temperature as discussed above) to help remove some of the existing fluid 26 from the wafer 10. As mentioned above, simply increasing the time for PEB to remove water droplets can still result in other types of defects. With the present lower temperature pre-bake, the problems that occur due to an increased amount of time for PEB are reduced or eliminated.

At step 110, a pattern developing process is performed on the exposed (positive) or unexposed (negative) resist 14 to leave the desired mask pattern. In some embodiments, the wafer 10 is immersed in a developer liquid for a predetermined amount of time during which a portion of the resist 14 is dissolved and removed. The wafer 10 may be immersed in the developer solution for about 5 to about 60 seconds, for example. The composition of the developer solution is dependent on the composition of the resist 14, and is understood to be well known in the art.

Although only a few exemplary embodiments of this invention have been described in detail above, those skilled in the art will readily appreciate that many modifications are possible in the exemplary embodiments without materially departing from the novel teachings and advantages of this invention. It is understood that various different combinations of the above-listed treatment steps can be used in various sequences or in parallel, and there is no particular step that is critical or required. Also, features illustrated and discussed above with respect to some embodiments can be combined with features illustrated and discussed above with respect to other embodiments. Accordingly, all such modifications are intended to be included within the scope of this invention.

For example, in one embodiment, a method of performing immersion lithography on a semiconductor substrate includes providing a layer of resist onto a surface of the semiconductor substrate and exposing the resist layer using an immersion lithography exposure system. The immersion lithography exposure system utilizes a fluid during exposure and may be capable of removing some, but not all, of the fluid after exposure. After exposure, a treatment process is used to remove the remaining portion of fluid from the resist layer. After treatment, a post-exposure bake and a development step are used.

In some embodiments, the treatment step utilizes a fluid. The fluid can be a gas, such as CDA (clean and/or compressed dry air), N2, or Ar. The gas can be a liquid such as supercritical carbon dioxide, isopropyl alcohol, a de-ionized water rinse, acid solution and/or a surfactant.

In some embodiments, a spin-dry step is used. The spin-dry step can operate at speeds over 1000 rpm.

In some embodiments, the treatment step utilizes a pre-bake process, which occurs prior to the post-exposure bake.

In some embodiments, the treatment step utilizes a vacuum process.

In another embodiment of the invention, a treatment system for use with an immersion lithography process is provided. The treatment system includes a fluid injection system for injecting a treatment fluid that is different from a lithography fluid being used by the immersion lithography process. The treatment system also includes a mechanism for removing both the treatment fluid and any remaining portions of the lithography fluid.

In some embodiments, the fluid injection system injects one or more of a CDA, N2, or Ar gas. In other embodiments, the fluid injection system injects one or more of supercritical carbon dioxide, isopropyl alcohol, a de-ionized water rinse, acid solution and/or a surfactant.

In some embodiments, the treatment system includes a spin-dry mechanism. In other embodiments, the treatment system includes a vacuum system.

In some embodiments, the treatment system includes a nozzle for injecting a fluid, a spin-dry mechanism, and a vacuum system.

Several different advantages exist from these and other embodiments. In addition to removing the water drop residue, many of the treatment steps can be performed without an increase in the immersion head air purge pressure. A better temperature profile for the wafer 10 can be obtained and the surface of the resist 14 is not modified. Many of the steps do not require separate chamber, and many of the steps are very low cost in terms of processing time, materials, and/or throughput.

We claim:

1. A method of performing immersion lithography on a semiconductor substrate, comprising:
providing a layer of resist onto a surface of the semiconductor substrate;
exposing the resist layer using an immersion lithography exposure system, the immersion lithography exposure system utilizing a fluid during exposure;
treating the resist layer after exposure and before a post-exposure bake;
performing the post-exposure bake on the resist layer; and
developing the exposed resist layer.

2. The method of claim 1, wherein the treatment step utilizes a fluid.

3. The method of claim 2 wherein the treatment step further utilizes a spin-dry step.

4. The method of claim 1, wherein the treatment step utilizes one of either CDA, N2, or Ar gas purge.

5. The method of claim 2, wherein the treatment step utilizes a supercritical carbon dioxide liquid.

6. The method of claim 2, wherein the treatment step utilizes an isopropyl alcohol liquid.

7. The method of claim 6 wherein the treatment step further utilizes a spin-dry step.

8. The method of claim 2, wherein the treatment step utilizes a surfactant liquid.

9. The method of claim 8 wherein the treatment step further utilizes a spin-dry step.

10. The method of claim 2, wherein the treatment step utilizes a de-ionized water rinse.

11. The method of claim 10 wherein the treatment step further utilizes a spin-dry step.

12. The method of claim 1 wherein the treatment step utilizes a vacuum process.

13. The method of claim 1 wherein the treatment step is a pre-bake to the post-exposure bake, the pre-bake being performed at a temperature that is less than a temperature used during the post-exposure bake.

14. A treatment system for use with an immersion lithography process, comprising:
a fluid injection system for injecting a treatment fluid that is different from a lithography fluid being used by the immersion lithography process; and
means for removing both the treatment fluid and any remaining portions of the lithography fluid.

15. The treatment system of claim 14, wherein the fluid injection system injects one or more of a CDA, N2, or Ar gas.

16. The treatment system of claim 15, wherein the fluid injection system includes a nozzle that swings from a center point of a substrate to an edge of the substrate.

17. The treatment system of claim 14, wherein the fluid injection system injects one or more of a supercritical carbon dioxide, isopropyl alcohol, or surfactant liquid.

18. The treatment system of claim 14 further comprising a spin-dry mechanism.

19. The treatment system of claim 14 further comprising a vacuum system.

20. The method of claim 2, wherein the treatment step utilizes acid solution rinse.

21. The method of claim 20, wherein the treatment step further utilizes a spin-dry step.
